(19) United States
(12) Patent Application Publication
(10) Pub. No.: US 2007/0013812 A1
(43) Pub. Date: Jan. 18, 2007

(54) Color reproduction system and color reproduction method

(75) Inventors: Takeyuki Ajito, Hachioji-shi (JP); Yasuhiro Komiya, Hino-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/493,274

(22) Filed: Jul. 26, 2006

Related U.S. Application Data
(63) Continuation of application No. PCT/JP05/01261, filed on Jan. 28, 2005.

(30) Foreign Application Priority Data
Jan. 29, 2004 (JP) 2004-021515

(51) Int. Cl. H04N 5/46

(52) U.S. Cl. 348/557

(57) ABSTRACT

A color reproduction system includes an image input apparatus configured to capture an image, a color correcting section configured to transform the colors of the image captured by the image input apparatus, and an image output apparatus configured to output by one of displaying and printing the image which is transformed the colors by the color correcting section. The color correcting section transforms the colors of the input image into those of an output image by using information on the lighting environment at the time of capturing the image, information on the lighting environment at the time of observing the image and information on the image input apparatus. The information on the lighting environment at the time of observing the image includes information on at least two lighting environments that are different from each other.

### CROSS-REFERENCE TO RELATED APPLICATIONS

This is a Continuation Application of PCT Application No. PCT/JP2005/001261, filed Jan. 28, 2005, which was published under PCT Article 21(2) in Japanese.

This application is based upon and claims the benefit of priority from prior Japanese Patent Application No. 2004-021515, filed Jan. 29, 2004, the entire contents of which are incorporated herein by reference.

### BACKGROUND OF THE INVENTION

1. Field of the Invention

This invention relates to a color reproduction system and a color reproduction method for accurately reproducing the colors of a subject for an image thereof under modified lighting conditions according to the lighting information in a camera shooting environment obtained from an image captured by a multi-band camera and lighting information in an image observing environment.

2. Description of the Related Art

Methods of estimating the colors of a subject from an image of the subject captured by a multi-band camera for the purpose of accurately reproducing a color image of the subject are proposed in U.S. Pat. No. 5,864,364, and U.S. Pat. No. 6,466,334 among others.

According to the methods disclosed in the U.S. Patent Documents, by using spectral information of illuminated light in the camera shooting environment and in the image observing environment, it is possible to accurately reproduce the color of a subject under illuminated light at an observation time even from the image captured by camera shooting under illuminated light different from the light at the observation time to display color image.

### BRIEF SUMMARY OF THE INVENTION

According to a first aspect of the present invention, there is provided a color reproduction system comprising:

an image input apparatus configured to capture an image;

a color correcting section configured to transform the colors of the image captured by the image input apparatus; and

an image output apparatus configured to output by one of displaying and printing the image which is transformed the colors by the color correcting section,

the color correcting section transforming the colors of the input image into those of an output image by using information on the lighting environment at the time of capturing the image, information on the lighting environment at the time of observing the image and information on the image input apparatus, and

the information on the lighting environment at the time of observing the image including information on at least two lighting environments that are different from each other.

According to a second aspect of the present invention, there is provided a color reproduction method comprising:

transforming the colors of an image captured by an image input apparatus; and

outputting at an image output apparatus by one of displaying and printing the image which is transformed the colors,

the transforming the colors being transformation of the colors of the input image into those of the output image by using information on the lighting environment at the time of capturing the image, information on the lighting environment at the time of observing the image and information on the image input apparatus, and

the information on the lighting environment at the time of observing the image including information on at least two lighting environments that are different from each other.

According to a third aspect of the present invention, there is provided a color reproduction system comprising:

image input means for capturing an image;

color correcting means for transforming the colors of the image captured by the image input means; and

image output means for outputting by one of displaying and printing the image which is transformed the colors by the color correcting means,

the color correcting means transforming the colors of the input image into those of an output image by using information on the lighting environment at the time of capturing the image, information on the lighting environment at the time of observing the image and information on the image input means, and

the information on the lighting environment at the time of observing the image including information on at least two lighting environments that are different from each other.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram of a first embodiment of color reproduction system according to the present invention, illustrating the overall configuration thereof;

FIG. 2 is a schematic illustration of an operation of metering light A for observation and light B for observation by the first embodiment;

FIG. 3 is a block diagram of the device-independent color image transforming section in FIG. 1, illustrating the configuration thereof in detail;

FIG. 4 is a block diagram of the device color image transforming section in FIG. 1, illustrating the configuration thereof in detail;

FIG. 5 is a schematic illustration of an operation of spectrally gauging light A for shooting and light B for shooting by a spectrometer instead of the lighting spectrum detection sensor in FIG. 1;

FIG. 6 is a schematic illustration of an arrangement that enables shooting a subject in direct light and diffused light component by a dome-shaped diffusion screen instead of direct light in FIG. 1;

FIG. 7 is a schematic illustration of an arrangement that enables shooting a subject in diffused light by spreading a transmission/diffusion sheet on a framework instead of the dome-shaped diffusion screen in FIG. 6;

FIG. 8 is a schematic block diagram of a second embodiment of color reproduction system according to the present invention, illustrating the overall configuration thereof;

FIG. 9 is a schematic illustration of a specific image capture operation of the second embodiment;

FIG. 10 is a schematic illustration of an operation of metering light A for observation and light B for observation by the second embodiment when outdoor natural light is selected for observation environment;

FIG. 11 is a schematic illustration of an operation gauging the lighting angle of direct light from the sun (light A for observation in FIG. 10) and adjusting the lighting angle for camera shooting according to the transmitted lighting angle;

FIG. 12 is a schematic illustration of an operation of spectrally gauging light A for shooting and light B for shooting by a spectrometer instead of the lighting spectrum detection sensor in FIG. 8;

FIG. 13 is a schematic illustration of an arrangement for outdoor shooting with isolated lighting by using a shade plate;

FIG. 14 is a schematic illustration of an operation of reproducing a “lighting-transformed” image in fine weather from an image taken by shooting with isolated lighting in cloudy weather;

FIG. 15 is a schematic illustration of the shading problem of diffused light when using a large shade plate;

FIG. 16 is a schematic illustration of a method of dissolving the shading problem of diffused light when the shade plate that is being used cannot be moved away from the subject;

FIG. 17 is a schematic illustration of a method of dissolving the shading problem of diffused light by using a blind when the shade plate that is being used cannot be moved away from the subject;

FIG. 18 is a schematic block diagram of a third embodiment of color reproduction system according to the present invention, illustrating the overall configuration thereof;

FIG. 19 is a schematic illustration of a specific image capture operation of the third embodiment;

FIG. 20 is a schematic illustration of a method of acquiring information on light A for observation and information on light B for observation by the third embodiment;

FIG. 21 is a schematic block diagram of a fourth embodiment of color reproduction system according to the present invention, illustrating the overall configuration thereof;

FIG. 22 is a schematic illustration of a method of acquiring information on light for observation No. 1 through light for observation No. 3 when outdoor natural light at dusk is selected for observation environment by a modified embodiment of the fourth embodiment;

FIG. 23 is a schematic illustration of a method of acquiring information on light for shooting No. 1 through light for shooting No. 3 by the modified embodiment of the fourth embodiment; and

FIG. 24 is a schematic block diagram of a fifth embodiment of color reproduction system according to the present invention, illustrating the overall configuration thereof.

### DETAILED DESCRIPTION OF THE INVENTION

Preferred embodiments of the present invention will be described below with reference to the accompanying drawings.

### First Embodiment

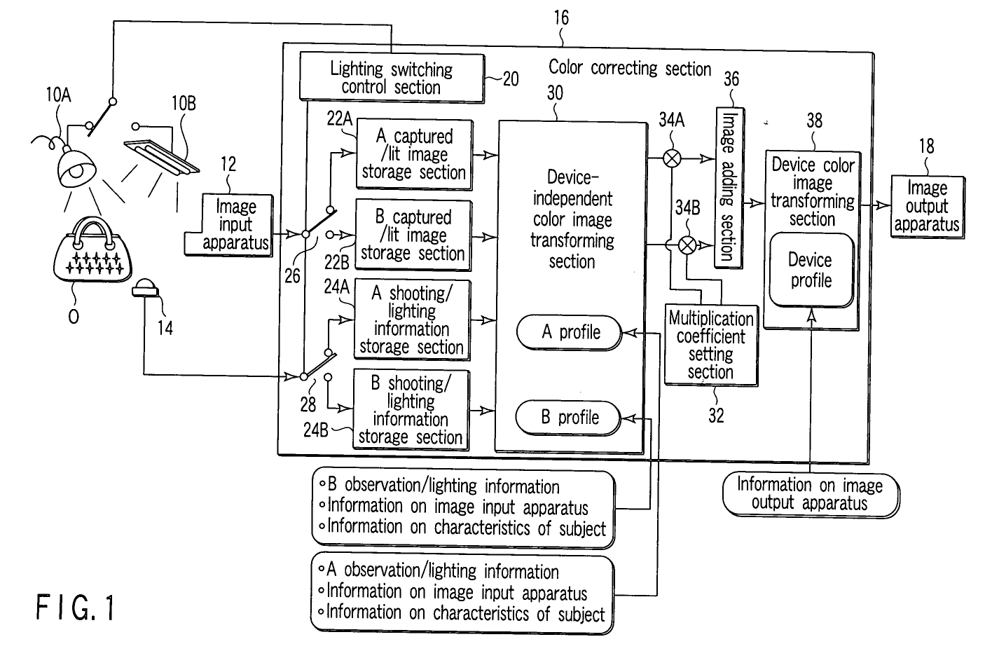

As shown in FIG. 1, the color reproduction system of a first embodiment comprises two light sources (light A for shooting 10A, light B for shooting 10B) for lighting subject O, an image input apparatus 12 that is a multi-band camera for capturing an image of the subject O, a lighting spectrum detection sensor 14 for detecting the spectral characteristics of light for shooting, a color correcting section 16 for correcting the colors of the image data input from the image input apparatus 12 and an image output apparatus 18 for outputting (displaying or printing) the image data obtained after correcting the colors of the image data by the color correcting section 16.

The color correcting section 16 includes a lighting switching control section 20, two captured/lit image storage sections (A captured/lit image storage section 22A, B captured/lit image storage section 22B), two shooting/lighting information storage sections (A shooting/lighting information storage section 24A, B shooting/lighting information storage section 24B), two switches 26, 28, device-independent color image transforming section 30, a multiplication coefficient setting section 32, two multipliers 34A, 34B, an image adding section 36 and a device color image transforming section 38.

Note that the light A for shooting 10A and the light B for shooting 10B come from different light sources as illustrated in FIG. 1. However, it may alternatively be so arranged that they come from a same light source and then from different lighting positions to produce light A and light B.

The lighting switching control section 20 switches the light A for shooting 10A and the light B for shooting 10B and also the switches 26, 28 in synchronism with the operation of switching the light A and the light B. More specifically, when the light A for shooting 10A is selected to light the subject O, the switch 26 is operated so as to store the image data input by the image input apparatus 12 (to be referred to as A captured/lit image data hereinafter) in the A shooting/lighting information storage section 24A and, at the same time, the switch 28 is operated so as to store the spectral characteristics of the light A for shooting 10A detected by the lighting spectrum detection sensor 14 (to be referred to as A shooting/lighting information hereinafter) in the A shooting/lighting information storage section 24A. On the other hand, when the light B for shooting 10B is selected to light the subject O, the switch 26 is operated so as to store the image data input by the image input apparatus 12 (to be referred to as B captured/lit image data hereinafter) in the B shooting/lighting information storage section 24B and, at the same time, the switch 28 is operated so as to store the spectral characteristics of the light B for shooting 10B from the lighting spectrum detection sensor 14 (to be referred to as B shooting/lighting information hereinafter) in the B shooting/lighting information storage section 24B.

The device-independent color image transforming section 30 transforms the A and B captured/lit image data stored respectively in the captured/lit image storage sections 22A, 22B into A and B device-independent color image data that are images of colors not dependent on the image input apparatus 12 and the image output apparatus 18. As will be described in greater detail hereinafter, the device-independent color image transforming section 30 prepares A and B profiles according to the A observation/lighting information, B observation/lighting information, the information on the image input apparatus and the information on the characteristics of the subject supplied from a storage medium, a network or some other source of information and the A shooting/lighting information and the B shooting/lighting information stored respectively in the shooting/lighting information storage sections 24A, 24B and performs a color transforming operation, using the A and B profiles. The device-independent color image transforming section 30 will be described in greater detail hereinafter.

The information on the image input apparatus includes characteristics of the image input apparatus 12 that is used for shooting and the selected parameters of the apparatus 12 and the information on the characteristics of the subject includes statistical properties of the spectrum of the subject O shot for an image.

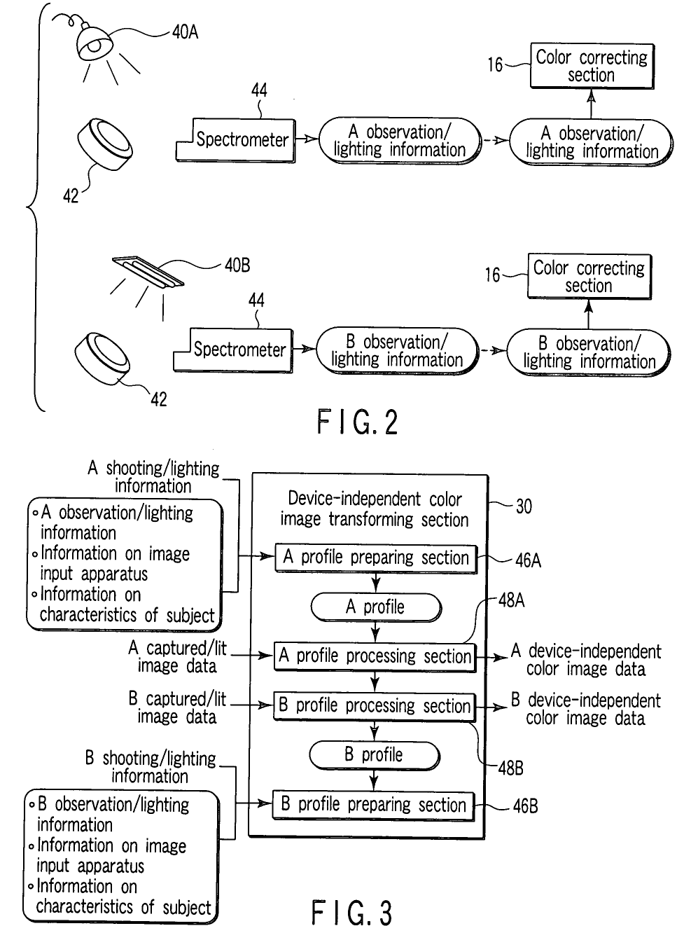

The observation/lighting information is spectral data of light at a place, which may be a remote site, where a person wants to observe the captured image of the subject O and is obtained as shown in FIG. 2, for example. A observation/lighting information is acquired by lighting a white plate 42 with light A for observation 40A and metering the light by a spectrometer 44. Similarly, B observation/lighting information is acquired by lighting the white plate 42 with light B for observation 40B and metering the light by the spectrometer 44. Then, the obtained observation/lighting information is supplied to the device-independent color image transforming section 30 of the color correcting section 16 by a network or a storage medium as indicated by broken lines in FIG. 2. It is only necessary to obtain spectral data of the light for observation when metering the light by lighting a object so that the object whose spectral reflectivity is known is used. In the illustrated instance, a standard white plate 42 is used because it shows a high reflectivity that changes little with time.

As the above-described information on the image input apparatus is used, it is possible to accurately estimate a color-reproduced image for the image input apparatus. It is also possible to reproduce colors if the image input apparatus is a multi-spectral camera adapted to capture a plurality of spectral images or a digital camera. Additionally, it is possible to cancel the influence of light at the time of capturing the image or images by using shooting/lighting information. In short, it is possible to accurately determine the spectral reflectivity of the subject O by computations in any light (e.g., from a fluorescent lamp, an incandescent lamp, the sun, etc.). Furthermore, it is possible to determine the colors of light at a place where a person wants to observe the image by computations by using the observation/lighting information. Finally, it is possible to accurately estimate a color-reproduced image if the input image provides little spectral information by using the information on the characteristics of the subject.

The image adding section 36 mixes the A device-independent color image data and the B device-independent color image data obtained by the device-independent color image transforming section 30. When mixing the data, it can change the mixing ratio of the A device-independent color image data and the B device-independent color image data. The mixing ratio can be changed as the user arbitrarily select multiplication coefficients by the multiplication coefficient setting section 32 and multiplying the A and B device-independent color image data respectively by the multiplication coefficient by the multipliers 34A, 34B.

The device color image transforming section 38 transforms the device-independent color image data obtained as a result of the mixing operation of the image adding section 36 into a color image data that matches the characteristics of the image output apparatus 18, referring to the device profile prepared to show the characteristics of the image output apparatus being used according to the information on the image output apparatus. Then, the device color image transforming section outputs the color image data obtained as a result of transformation to the image output apparatus 18. The device color image transforming section 38 will be described in greater detail hereinafter.

To begin with, the color reproduction system having the above-described configuration separately captures images of the subject O in a plurality of different lighting conditions. Then, the system transforms the colors of the images captured in the plurality of lighting conditions according to the spectral information on the light used for shooting the subject O and the spectral information on the light to be used for observation. Then, the system acquires a reproduced image in the mixture of a plurality of light by mixing the images showing the transformed colors.

As a result of the above-described process, it is possible to accurately reproduce the colors of the subject O if the original images are captured in outdoor natural light that is a mixture of direct light from the sun and light diffused by the surrounding blue sky. Additionally, in the case of indoor lighting, the colors of the subject O may appear differently when it is in spotlight and when it is in light reflected by the surroundings. However, as a result of the above-described process, it is possible to accurately reproduce the colors of the subject O if it is in mixed light of a plurality of colors.

As shown in FIG. 3, the above-described device-independent color image transforming section 30 includes an A profile preparing section 46A, an A profile processing section 48A, a B profile preparing section 46B and a B profile processing section 48B.

The A profile preparing section 46A computationally determines an A profile according to the A shooting/lighting information input from the A shooting/lighting information storage section 24A, the externally input A observation/lighting information, the information on the image input apparatus and the information on the characteristics of the subject. The A profile processing section 48A causes the A profile prepared by the A profile preparing section 46A to act on the A captured/lit image data stored in the A captured/lit image storage section 22A for color transformation and acquires an A device-independent color image data.

Similarly, the B profile preparing section 46B computationally determines a B profile according to the B shooting/lighting information input from the B shooting/lighting information storage section 24B, the externally input B observation/lighting information, the information on the image input apparatus and the information on the characteristics of the subject. The B profile processing section 48B causes the B profile prepared by the B profile preparing section 46B to act on the B captured/lit image data stored in the B captured/lit image storage section 22B for color transformation and acquires a B device-independent color image data.

Note that, in this embodiment, the A and B profile preparing sections 46A, 46B are formed as matrix preparing sections and the A and B profile processing sections 48A, 48B are formed as matrix operation sections. As profiles are caused to act on image data by way of matrix operations, it is possible to transform captured/lit image data into device-independent color image data at high speed.

Thus, if the output signal of the multi-spectral camera that is the image input apparatus 12 is gᵢ, gᵢ is expressed by the formula below.

[formula 1]
gᵢ=∫eₘ(λ)●ƒ(λ)●hᵢ(λ)●dλ (1),
Where eₘ(λ): spectrum of light for shooting
f(λ): spectral reflectivity of subject
hᵢ(λ): sensitivity of image input
   apparatus when filter i is used.

The stimulus values XYZ are expressed as follows when a person observes a subject O.

[formula 2]
X=∫e₀(λ)●ƒ(λ)●x(λ)●dλ
Y=∫e₀(λ)●ƒ(λ)●y(λ)●dλ
Z=∫e₀(λ)●ƒ(λ)●z(λ)●dλ (2),
where e₀(λ): spectrum of light for observation
f(λ): spectral reflectivity of subject
x(λ), y(λ), z(λ): color matching
   functions.

Thus, it is sufficient to computationally determine matrices (profiles) M expressed by the formula below. In the formula below, t represents a transposed matrix.

[formula 3]
M●g=[X, Y, Z]^{t} (3)

The evaluation function designs M so as to minimize the formula (4) below.

[formula 4]
e²=E[(X−M●g)²] (4),
where E[ ] represents the operator for determining the expected value.

M as determined by the formula (5) below is a least square filter.
[formula 5]

$$\frac{\partial {ⅇ}^{2}}{\partial M} = 0 \qquad ( 5 )$$

The filter M is given by the formula (6) shown below.

[formula 6]
M=A●B⁻¹
Aᵢⱼ=∫∫e₀(λ)●xᵢ(λ)●E[ƒ(λ)●ƒ(λ′)]●eₘ(λ′)●hⱼ(λ′)●dλ●dλ′
Bᵢⱼ=∫∫eₘ(λ)●hᵢ(λ)●E[ƒ(λ)●ƒ(λ′)]●eₘ(λ′)●hⱼ(λ′)●dλ●dλ′ (6)

E[f(λ)·f(λ′)] in the above formula (6) expresses the spectral correlation term of the subject O. When reducing the average of the evaluation function for any object, the matrix becomes a unit matrix and the filter M is expressed by the formula (7) below.

[formula 7]
M=A●B⁻¹
Aᵢⱼ=∫e₀(λ)●xᵢ(λ)●eₘ(λ)●hⱼ(λ)●dλ
Bᵢⱼ=∫eₘ(λ)²●hᵢ(λ)●dλ (7)

If it is possible to limit the subject O to a certain extent and express the distribution of spectral reflectivity by a small number of bases, colors can be estimated accurately from a small number of spectral images. For example, in the case of remote medical treatment, the color of the patient body can be reproduced accurately from a small number of spectral images by measuring the spectral reflectivity of the colors of the skin of the patient and predetermining the correlate on matrix for statistic properties.

Thus, the A and B profile preparing sections 46A, 46B carry out computations, using the above formula (6) when the system executes a color reproduction process, using the information on the characteristics of the subject, whereas they carry out computations, using the above formula (7) when the system executes a color reproduction process without using the information on the characteristics of the subject. Then, the A and B profile processing sections 48A, 48B apply the image data filter M respectively to the A and B captured/lit images. That is, the sections 48A, 48B carry out computations, using the above formula (3).

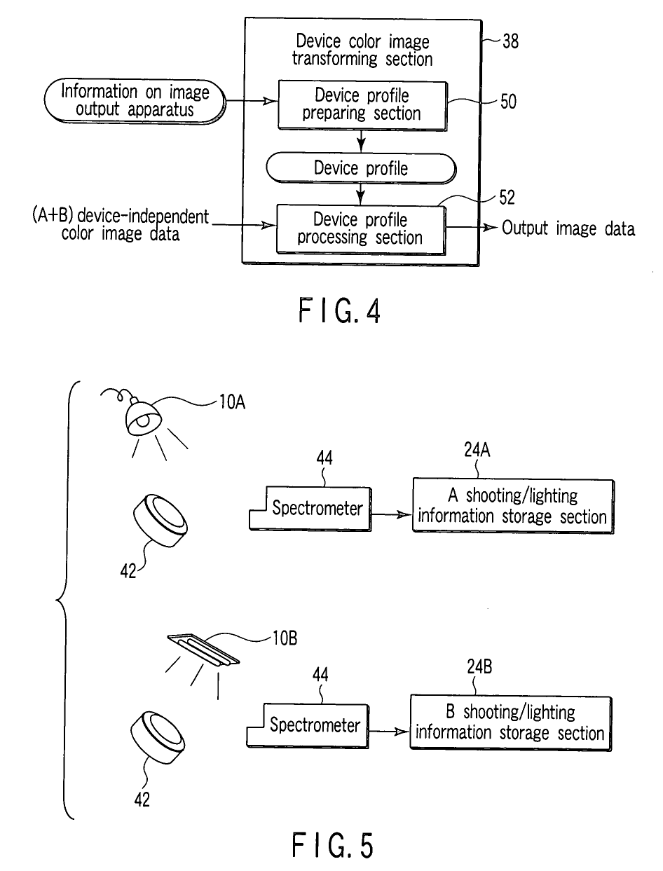

As shown in FIG. 4, the device color image transforming section 38 includes a device profile preparing section 50 and a device profile processing section 52. The device profile preparing section 50 computationally determines the device profile according to the information on the image output apparatus that is given externally. The device profile processing section 52 causes the device profile prepared by the device profile preparing section 50 to act on the device-independent color image data obtained as a result of the mixing operation of the image adding section 36 for color transformation and acquires output image data.

The image output apparatus 18 to be used for the system, which may typically be a monitor, is set at a place that is not influenced by external light such as in a darkroom with a chromaticity meter (not shown) to be used for metering chromaticity and a predetermined RGB signal is applied from an RGB signal generating section (not shown) to it so as to display an image of a corresponding color. Then, the color displayed on the monitor is metered by the chromaticity meter and the signal output form the chromaticity meter is detected as chromaticity value such as XYZ value by a chromaticity detecting section (not shown). The detected chromaticity value is then transmitted to the device profile preparing section 50 as information on the image output apparatus. The device profile preparing section 50 computationally determines the device profile from the relationship between the RGB value generated by the RGB signal generating section (not shown) and the chromaticity value of the information on the image output apparatus.

Now, the relationship between the RGB value output to the monitor, or the image output apparatus 18 to be used for the system, and the XYZ value output from the monitor will be described. The monitor has RGB fluorescent bodies and transmits signal to the RGB fluorescent bodies to display a color image. The signal value (RGB value) to be transmitted to the RGB fluorescent bodies is generated by the RGB signal generating section (not shown). The RGB value is transformed into a non-linear type signal according to the γ characteristic of the monitor. Then, the monitor reduces the γ characteristic of RGB to γr[ ], γg[ ] and γb[ ]. Since man recognizes the sum of the colors of the RGB fluorescent bodies as color, the chromaticity value (XYZ value) as expressed by the formula (8) below is obtained by adding the signal value that reflects the y characteristic and output from the monitor.
[formula 8]

$$( \begin{matrix}\begin{matrix}X \\ Y\end{matrix} \\ Z\end{matrix} ) = ( \begin{matrix}Xr max & Xg max & Xb max \\ Yr max & Yg max & Yb max \\ Zr max & Zg max & Zb max\end{matrix} ) ( \begin{matrix}\begin{matrix}γ r [ R ] \\ γ g [ R ]\end{matrix} \\ γ b [ R ]\end{matrix} ) \qquad ( 8 )$$

In the above formula (8), Xrmax, Yrmax and Zrmax represent the XYZ value for the highest luminance of the R fluorescent body and Xgmax, Ygmax and Zgmax represent the XYZ value for the highest luminance of the G fluorescent body, while Xbmax, Ybmax and Zbmax represent the highest luminance of the B fluorescent body.

The RGB value for obtaining a desired XYZ value can be computationally determined by utilizing the above formula (8). In other words, it is computationally determined by way of matrix transformation and y correction as shown by the formula (9) below.

[formula 9]

matrix transformation

$$( \begin{matrix}\begin{matrix}{R}^{′} \\ {G}^{′}\end{matrix} \\ {B}^{′}\end{matrix} ) = {( \begin{matrix}Xr max & Xg max & Xb max \\ Yr max & Yg max & Yb max \\ Zr max & Zg max & Zb max\end{matrix} )}^{- 1} ( \begin{matrix}\begin{matrix}X \\ Y\end{matrix} \\ Z\end{matrix} ) \qquad ( 9 )$$

γ correction
R=γr⁻¹[R′]
G=γg⁻¹[G′]
B=γb⁻¹[B′]

The device profile preparing section 50 computationally determines the matrix coefficient for the matrix transformation and the γ correction value for the γ correction from the RGB value and the XYZ value as device profile. Then, the device profile processing section 52 performs a matrix transformation and a γ correction on the device-independent color image data, utilizing the matrix coefficient and the γ correction value, and outputs the RGB value to be output to the image output apparatus 18.

The above description applies to an instance where the color image is output to and displayed on the image output apparatus 18 that is a monitor. When the color image is output to the image output apparatus 18 that is a printer, it is equally possible to obtain information on the image output apparatus and prepare a device profile according to the information on the image output apparatus.

While the lighting spectrum detection sensor 14 is used in the arrangement illustrated in FIG. 1, the lighting spectrum detection sensor 14 may be replaced by a white plate 42 and a spectrometer 44 as shown in FIG. 5.

Inversely, while a white plate 42 and a spectrometer 44 are used in the arrangement illustrated in FIG. 2, they may be replaced by a lighting spectrum detection sensor 14.

Additionally, if both of the A captured/lit image data and the B captured/lit image data are for 3-band images, they may be stored together as captured/lit image data for 6-band images. If such is the case, profiles are prepared as 6×3 matrix by combining the A shooting/lighting information and the B shooting/lighting information. Then, the image adding section 36 can be omitted because the profile processing sections operate for adding image data by way of matrix transformation.

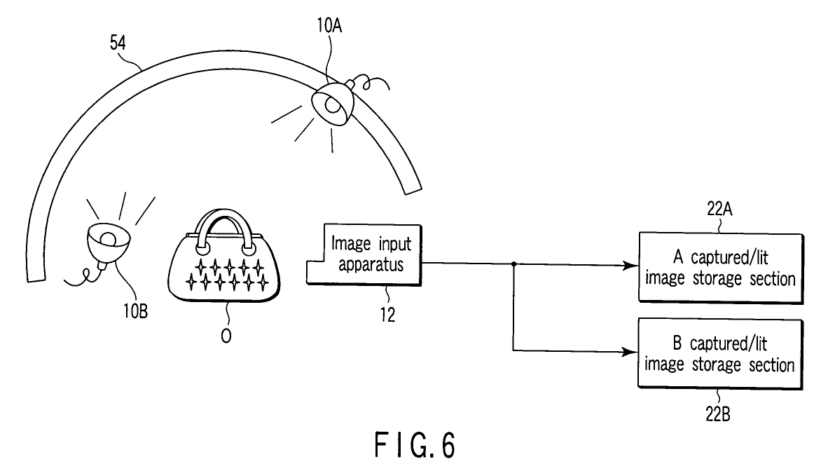

While light A for shooting 10A and light B for shooting 10B for lighting the subject O are direct light in this embodiment, the present invention is by no means limited thereto. For example, as shown in FIG. 6, a dome-shaped diffusion screen 54 may be prepared to cover the subject O and the subject O may be lit by direct light of light A for shooting 10A and reflected light of light B for shooting 10B that is reflected by the dome-shaped diffusion screen 54. With this arrangement, it is possible to almost accurately reproduce lighting by outdoor natural light that is a mixture of direct light from the sun and diffused light from the surrounding blue sky. In other words, it is possible to accurately transform such lighting into outdoor natural light.

Particularly, in order to accurately reproduce a natural light and blue sky environment (in terms of lighting), it is desirable to shed diffused light from right above the subject O toward the side of the subject O facing the image input apparatus 12 in addition to light shed onto the back side and the lateral sides of the subject O as shown in FIG. 6. With such an arrangement, even if the mirror-reflected light is strongly irradiated onto the subject O, it is possible to accurately transform such lighting into outdoor natural light that may include light coming from the blue sky.

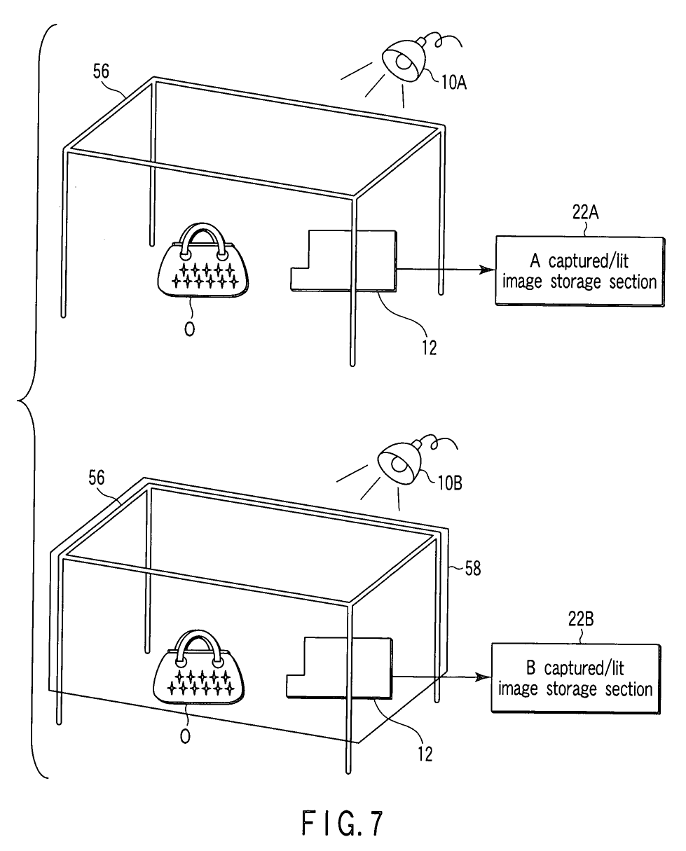

The dome-shaped diffusion screen 54 may be replaced by a framework 56 that is arranged between the subject O and light A for shooting 10A and light B for shooting 10B and covered by a transmission/diffusion sheet 58 as shown in FIG. 7. With such an arrangement, an image of the subject O is captured firstly in light A for shooting 10A without using the transmission/diffusion sheet 58 and then another image of the subject O is captured in light B for shooting 10B with the transmission/diffusion sheet 58 spread over the framework 56. Thus, it is possible to capture an image of the subject O in direct light and another image in diffused light separately as in the above-described instance. The transmission/diffusion sheet 58 may be replaced by a see-through display screen having characteristics that can be modified for transparency/opacity (diffusion) by electrically controlling it from the outside.

### Second Embodiment

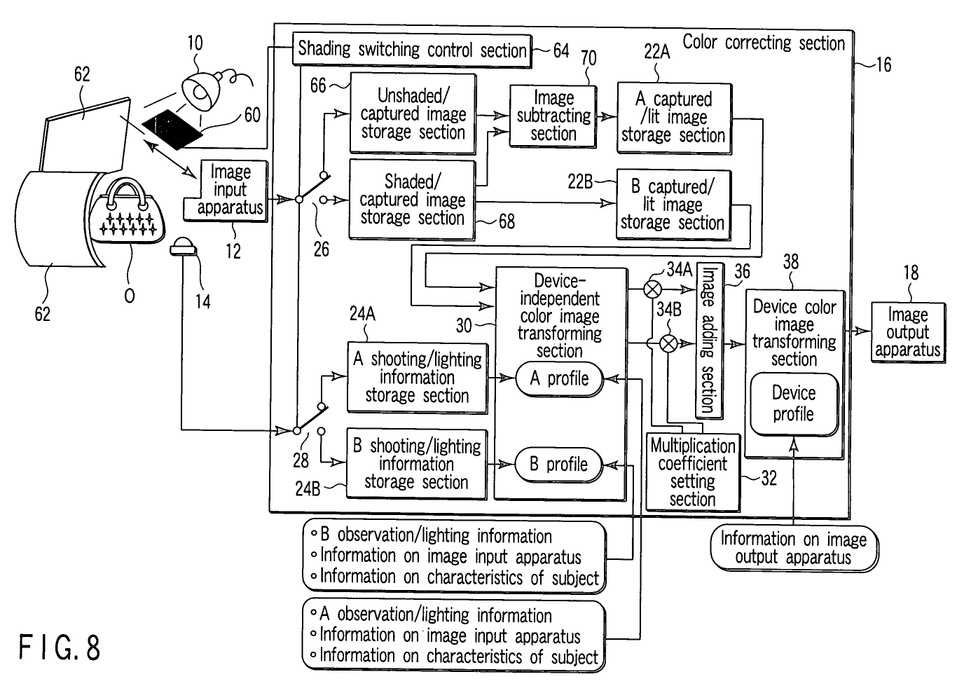

As shown in FIG. 8, the color reproduction system according to a second embodiment of the present invention employs not light A for shooting 10A and light B for shooting 10B but only light for shooting 10. However, it additionally comprises a shade plate 60 and a light reflecting plate 62 in order to acquire A and B captured/lit image data. In the color correcting section 16, the lighting switching control section 20 is replaced by a shading switching control section 64. The color correcting section 16 additionally includes an unshaded/captured image storage section 66, a shaded/captured image storage section 68 and an image subtracting section 70.

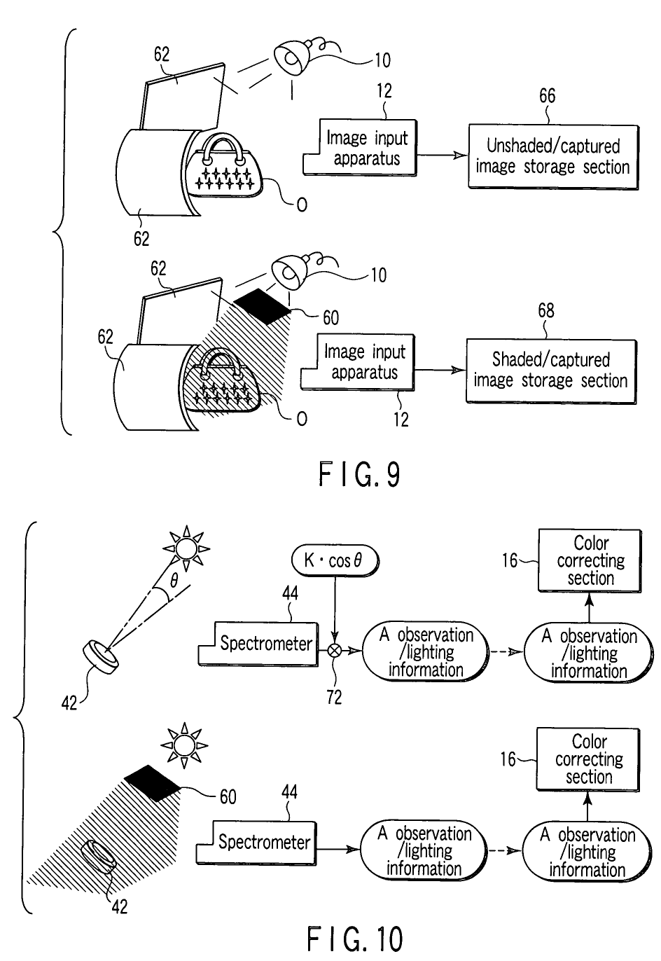

The shading switching control section 64 switches the shade plate 60 from a position where it is located in front of light for shooting 10 (at the side of the subject O) to a position where it is not located in front of light for shooting 10 and vice versa. The switches 26, 28 are operated by the positional switching. More specifically, when the shade plate 60 is moved away from the front side of light for shooting 10 so that the subject O is lit both directly by light for shooting 10 and by reflected light from the light reflecting plate 62 as shown in FIG. 9, the captured image data from the image input apparatus 12 is stored in the unshaded/captured image storage section 66. On the other hand, when the shade plate 60 is placed in front of light for shooting 10 so that the subject O is lit not directly by light for shooting 10 but only by reflected light from the light reflecting plate 62, the captured image data from the image input apparatus 12 is stored in the shaded/captured image storage section 68. The captured image data of an image in direct light for shooting 10 is extracted as the captured image data stored in the shaded/captured image storage section 68 is subtracted from the captured image data stored in the unshaded/captured image data storage section 66 by the image subtracting section 70. The extracted captured image data is then stored in the A captured/lit image storage section 22A. On the other hand, the captured image data stored in the shaded/captured image storage section 68 is directly stored in the B captured/lit image storage section 22B. In this way, an image lit by the direct light component (to be referred to as light A for shooting hereinafter) is captured by subtracting the shaded/captured image from the unshaded/captured image and the shaded/captured image is used as image lit by the surrounding diffused light component (to be referred to as light B for shooting hereinafter).

The shooting/lighting information from the lighting spectrum detection sensor 14 is stored in the A shooting/lighting information storage section 24A when the shade plate 60 is moved away from the front side of the light for shooting 10 and in the B shooting/lighting information storage section 24 when the shade plate 60 is placed in front of the light for shooting 10.

Otherwise, the operation of the device-independent color image transforming section 30 and the subsequent operations of this embodiment is same as those of the first embodiment and hence will not be described here any further.

It should be noted here, however, the white plate 42 and the spectrometer 44 are used to acquire A observation/lighting information and B observation/lighting information both in a state where the shade plate 60 is placed in position and in a state where the shade plate 60 is moved away from its position. Outdoor natural light is assumed for light for observation here and the lighting spectrum of the direct light component from the sun and that of the surrounding diffused light component are metered.

In FIG. 10, θ denotes the angle of incidence of sunlight relative to a normal to the surface of the white plate 42. Normally, when metering direct light from the sun, the absolute value of the metered value changes as the angle of incidence θ of sunlight changes to make it impossible to accurately acquire the ratio of direct light to diffused light. Therefore, a coefficient that is proportional to cos θ and hence changes as a function of the angle of incidence θ of sunlight is used as multiplicator by multiplier 72 to computationally determine A observation/lighting information in order to correct the metered value to the value of direct light under predetermined metering conditions.

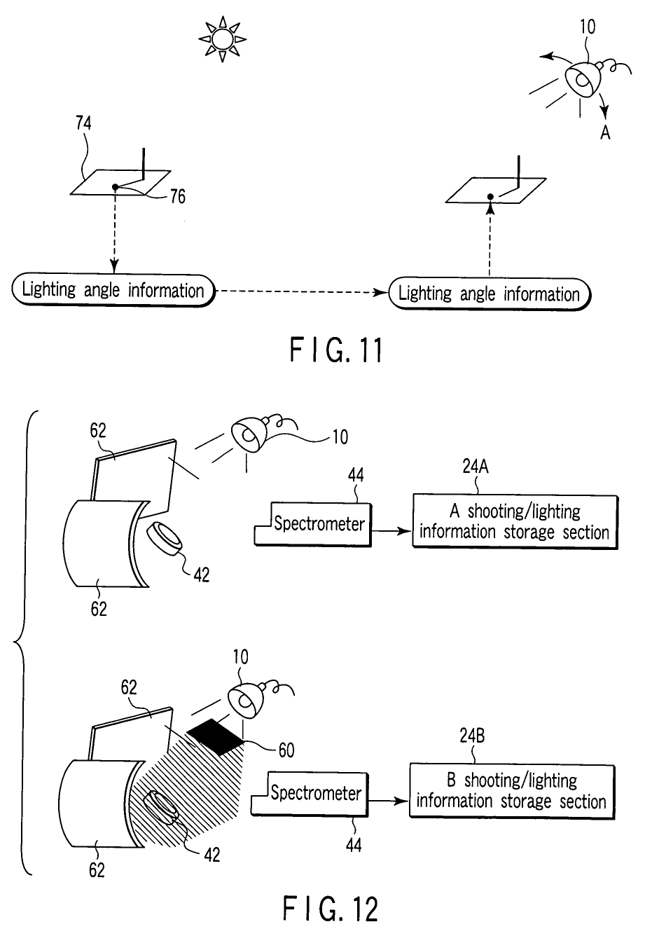

When outdoor natural light is used as light for observation, it is preferable to meter the angle of incidence of sunlight at the observing side and transfer the metered angle to the shooting side so that the shooting conditions may be so adjusted as to make the angle of the sun and the angle of light for shooting agree with each other. Therefore, the position of a marker (the shadow front end position) 76 metered by a lighting angle detector 74 as shown in FIG. 11 is transferred to the shooting side as lighting angle information by way of a network or a storage medium as indicated by a broken line in FIG. 11. Then, the lighting angle of light for shooting 10 is adjusted in either of the directions indicated by arrows A in FIG. 11 according to the transferred lighting angle information.

As described above, when a direct light component and an indirect light component of a single light source are included in a plurality of light, those components cannot selectively be used by the first embodiment but the color reproduction system of the second embodiment can separate them and use them selectively for shooting a subject.

As in the case of the first embodiment, the lighting spectrum detection sensor 14 may be replaced by a white plate 42 and a spectrometer 44 as shown in FIG. 12 to acquire A shooting/lighting information and B shooting/lighting information by metering also in this embodiment.

The reflecting plate 62 may be plate-shaped or dome shaped. Furthermore, the light reflecting plate 62 may be a total reflection plate such as a mirror or a diffusion/reflection plate. An appropriate light reflecting plate may be selected depending on the conditions of the observation side.

Additionally, a light source dedicated to the light reflecting plate 62 and hence adapted to shed light exclusively toward the light reflecting plate 62 without directly lighting the subject O may be provided separately in addition to light for shooting 10.

The above-described embodiment can adapt itself not only to indoor shooting with isolated lighting but also to outdoor shooting with isolated lighting by using a shade plate 60.

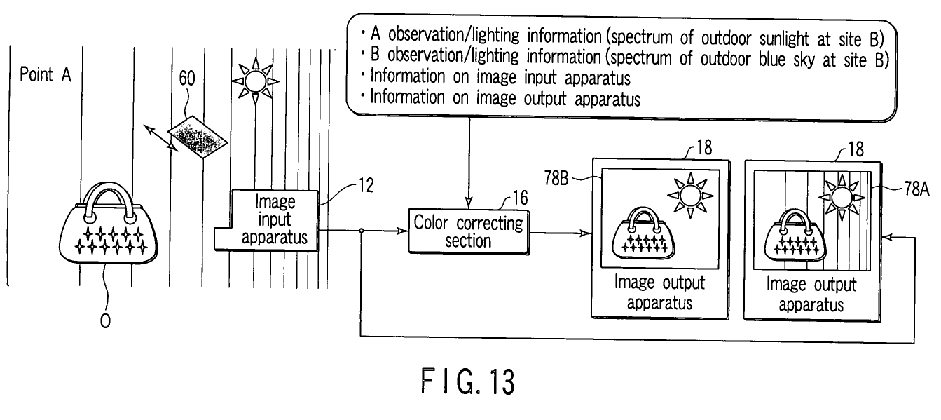

Then, as shown in FIG. 13, it is possible to transform an image captured at outdoor site A by using the shade plate 60 (outdoor captured image 78A at site A) into an image captured in outdoor light at another outdoor site B (transformed image with outdoor lighting 78B at site B).

Additionally, also as shown in FIG. 13, two image output apparatus 18 may be arranged (or two image display regions may be arranged on a single image output apparatus) to display the transformed image with outdoor lighting 78B at site B on one of them and the outdoor captured image 78A at site A on the other without transformation of lighting (although both the image input apparatus 12 and the image output apparatus 18 are calibrated). With such an arrangement, it is possible to clearly display the difference of appearance of the colors of the subject O in outdoor light between at site A and at site B. Then, the color designer can recognize the change of the colors of the subject O and efficiently operates for the color design of the subject O without actually bringing the object O to the site B. It may be needless to say that the designer can recognize the difference among the actual subject O and the images and operates more efficiently for the color design when he or she puts the real subject O at site A with the two displayed images for comparison.

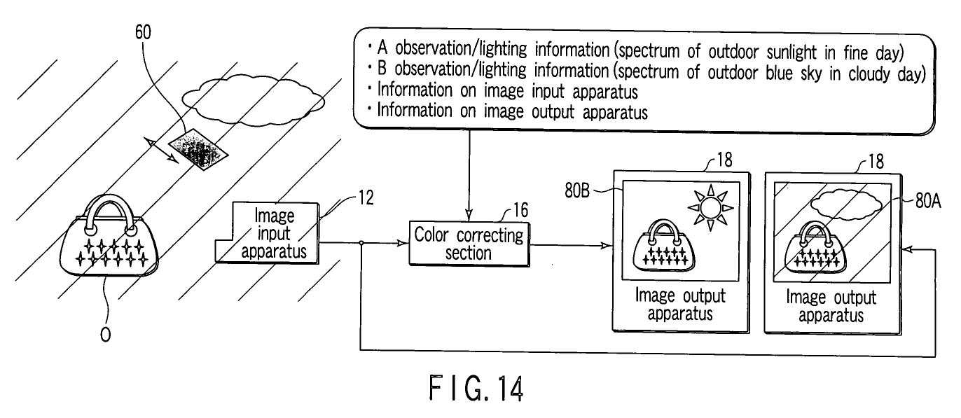

It is possible to shoot the subject O in the diffused light component and in the direct light (parallel light) component of light separately to obtain two different images by using the shade plate 60 not only in a fine day but also in a cloudy day as shown in FIG. 14. Then, it is possible to reproduce an image captured in a cloudy day (captured image 80A in a cloudy day) so as to make it appear as if it were an image captured in a fine day (captured image 80B in a fine day).

In such a case again, two image output apparatuses 18 may be arranged (or two image display regions may be arranged on a single image output apparatus) to display the captured image 80A in a cloudy day on one of them and the captured image 80B in a fine day on the other for the purpose of comparison.

When shooting the subject O with isolated lighting, using the shade plate 60 as described above by this embodiment, care should be taken for the following problem.

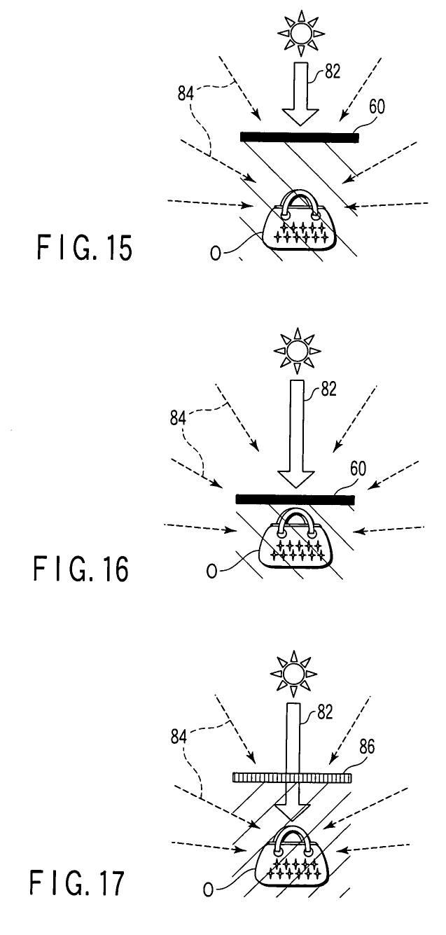

When direct light is blocked by the shade plate 60, not only direct light 82 from the sun but also part of diffused light 84 from the surrounding blue sky can be blocked if the shade plate 60 is large as shown in FIG. 15. For diffused light 84 not to be blocked, it is necessary to move the shade plate 60 away from the subject O as much as possible (at least by a distance equal to the size (diagonal length) of the shade plate 60).

If, however, it is not possible to move the shade plate 60 sufficiently far away from the positional restrictions of the site, this problem may be dissolved by either of the two techniques described below.

With one of the techniques, several images of the subject O are captured by changing the distance between the shade plate 60 and the subject O and hence the ratio by which diffused light is blocked as shown in FIG. 16 and an image in totally unblocked diffused light is estimated from the differences of the images.

With the other technique, a blind 86 is used as shade plate and an image of the subject O is captured with the blind 86 in a closed state (in a state as illustrated in FIG. 15) and then another image of the subject O is captured with the blind 86 wide open as shown in FIG. 17. Then, the diffused light component that is blocked by the shade plate is determined from the difference and an image that is captured by blocking only direct light is obtained by correcting the former images.

### Third Embodiment

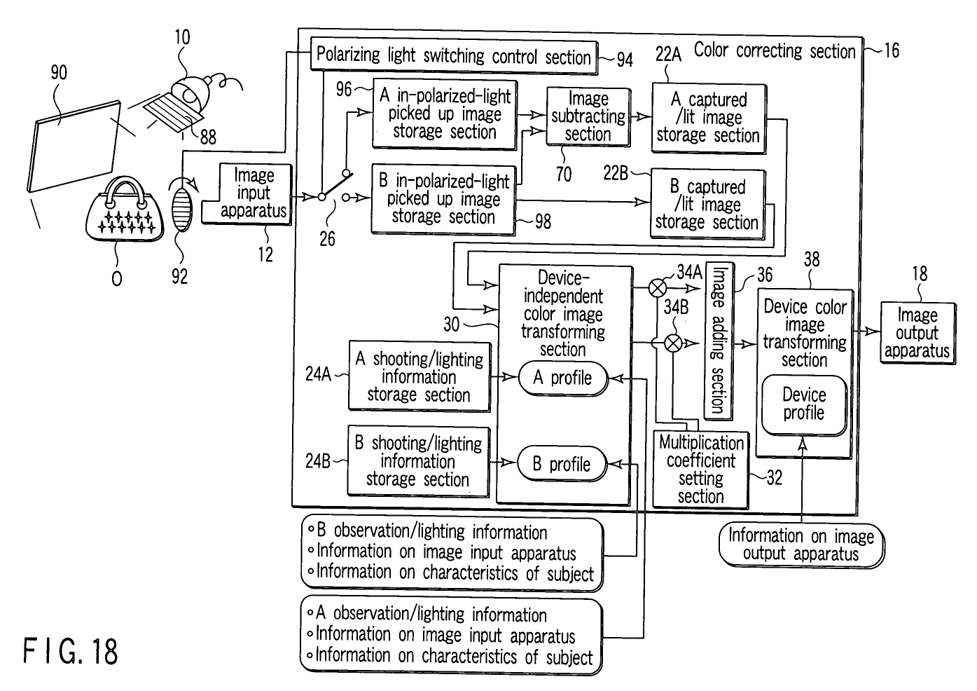

As shown in FIG. 18, the color reproduction system according to a third embodiment of the present invention is formed by replacing the shade plate 60 and the light reflecting plate 62 of the above-described second embodiment by a polarizing plate 88, a diffusion reflecting plate 90 and a rotary polarizing plate 92. With the above-described modifications, the shading switching control section 64 is replaced by a polarizing light switching control section 94 and the unshaded/captured image storage section 66 and the shaded/picked up image storage section 68 are replaced by an A in-polarized-light picked up image storage section 96 and B in-polarized-light picked up image storage section 98 for this embodiment.

With the above-described arrangement, the subject O is lit by direct light that is polarized by the polarizing plate 88 arranged in front of light for shooting 10 and indirect light that is produced as direct light is diffused by the diffusion reflecting plate 90 and brought into an unpolarized state.

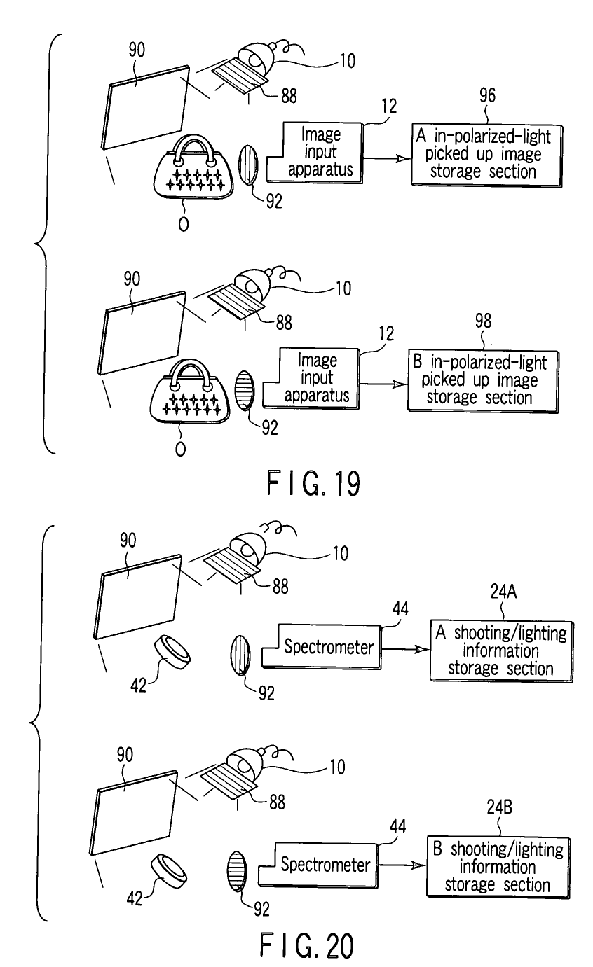

Then, as shown in FIG. 19, when the rotary polarizing plate 92 arranged between the image input apparatus 12 and the subject O is put to a position for producing polarized light same as polarized light produced by the polarizing plate 88 by the polarizing light switching control section 94, the image data obtained by an image capture operation of the image input apparatus 12 is stored in the A in-polarized-light picked up image storage section 96. In other words, a picked up image data like the one obtained without the shade plate of the second embodiment is obtained because the rotary polarizing plate 92 produces a polarizing effect same as the polarizing plate 88.

To the contrary, the image data obtained by an image capture operation of the image input apparatus 12 when the rotary polarizing plate 92 is put to a position for producing polarized light orthogonal relative to polarized light produced by the polarizing plate 88 by the polarizing light switching control section 94 is stored in the B in-polarized-light picked up image storage section 98. In other words, the direct light component is cut by the rotary polarizing plate 92 so that the captured image data of an image captured in light of the unpolarized indirect light component is obtained. The captured image data is like a captured image data obtained with the shade plate of the second embodiment.

Thus, the arrangement of the color reproduction system of the third embodiment is effective when the shade plate 60 of the second embodiment cannot be placed at an appropriate position or in an appropriate range. The polarizing plates 88, 92 may be small ones because they can be placed at respective positions near light for shooting 10 and the image input apparatus 12.

Note that the lighting spectrum detection sensor 14 and the switch 28 are not shown in FIG. 18 for the purpose of simplicity.

It may be needless to say that the lighting spectrum detection sensor 14 may be replaced by a white plate 42 and a spectrometer 44 as shown in FIG. 20 to obtain A shooting/lighting information and B shooting/lighting information by metering as described above by referring to the first embodiment.

### Fourth Embodiment

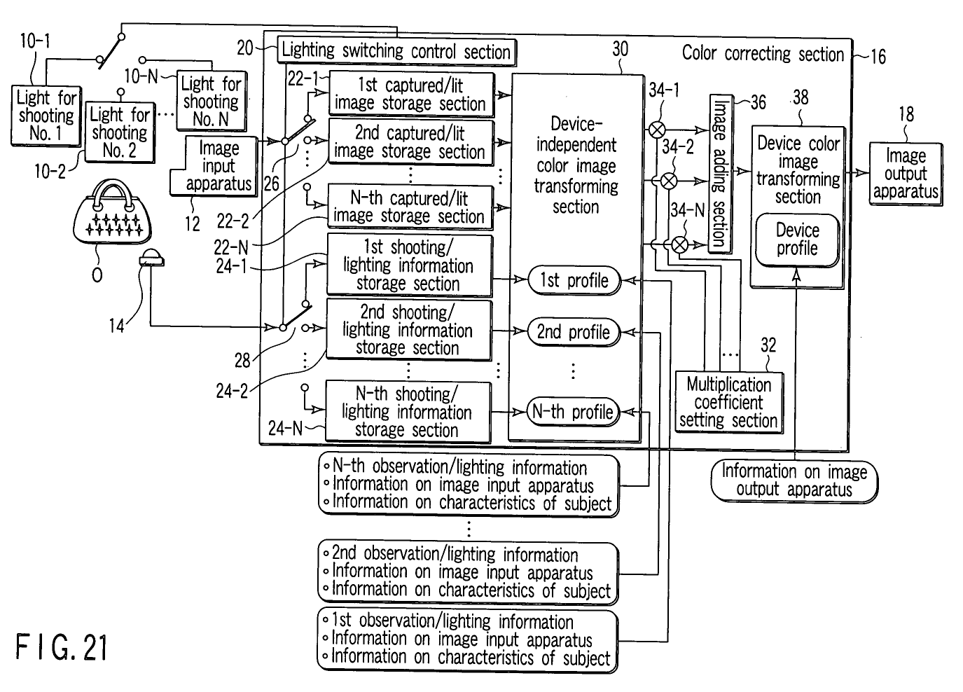

While light for shooting of two different kinds and light for observation of two different kinds are used in the above-described first embodiment, a fourth embodiment of color reproduction system according to the present invention uses light 10-1 for shooting through light 10-N for shooting and light for observation of N different kinds, N being an integer not less than 3, as shown in FIG. 21.

Thus, with this embodiment, it is possible to provide a simulation apparatus for simulating appearances of the colors of a subject O in light for observation that can be differentiated in various ways by altering the multiplication coefficient set by the multiplication coefficient setting section 32.

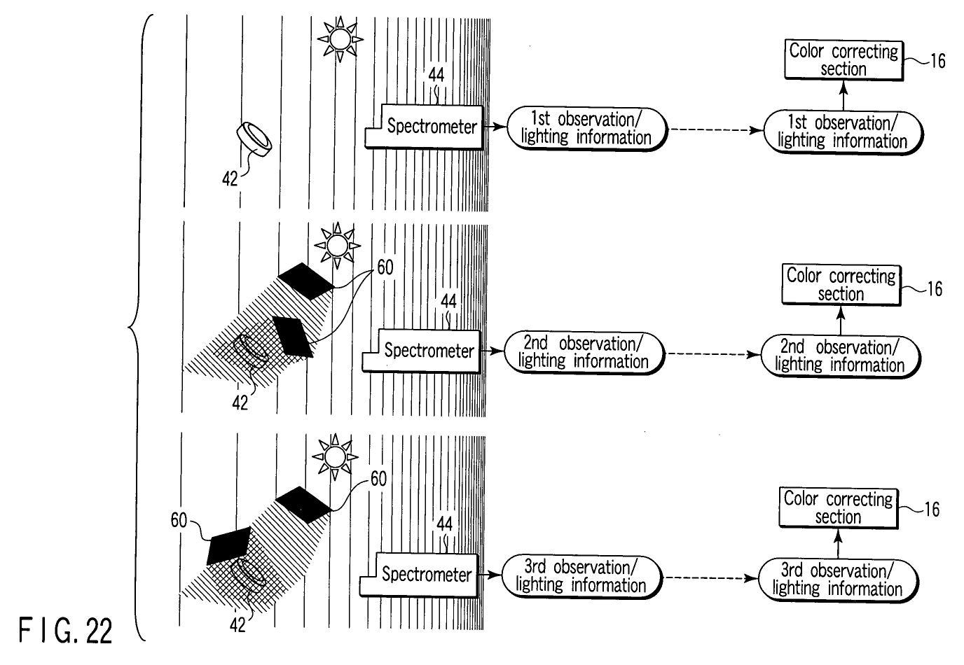

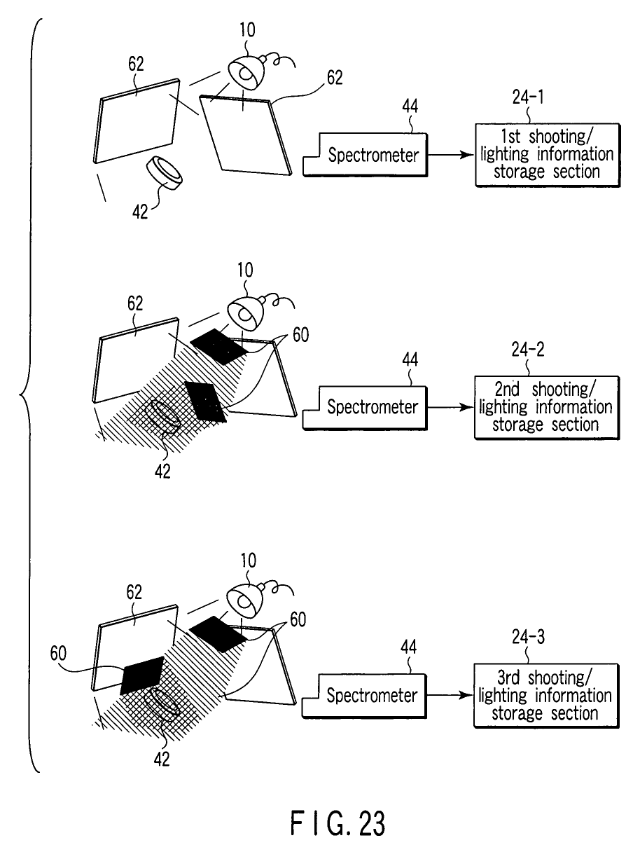

It is also possible to provide various differently lit environments by blocking light as in the case of the above-described second embodiment instead of using light 10-1 for shooting through light 10-N for shooting of N different kinds, N being an integer not less than 3. Then, the direction of shedding light that is to be blocked may be changed in various different ways. Information on light for observation can be obtained by the spectrometer 44 while light from the white plate 42 is blocked by a plurality of shade plates 60 as shown in FIG. 22. Note that, in FIG. 22, outdoor natural light at dusk (direct light from the sun being red, indirect light from areas of the sky far from the sun being blue) is selected for observation environment. Information on light for shooting is acquired by the spectrometer 44 as shown in FIG. 23.

With the above-described arrangement, it is possible to accurately reproduce colors when diffused light from the surrounding sky includes several colors like natural light at dusk.

### Fifth Embodiment

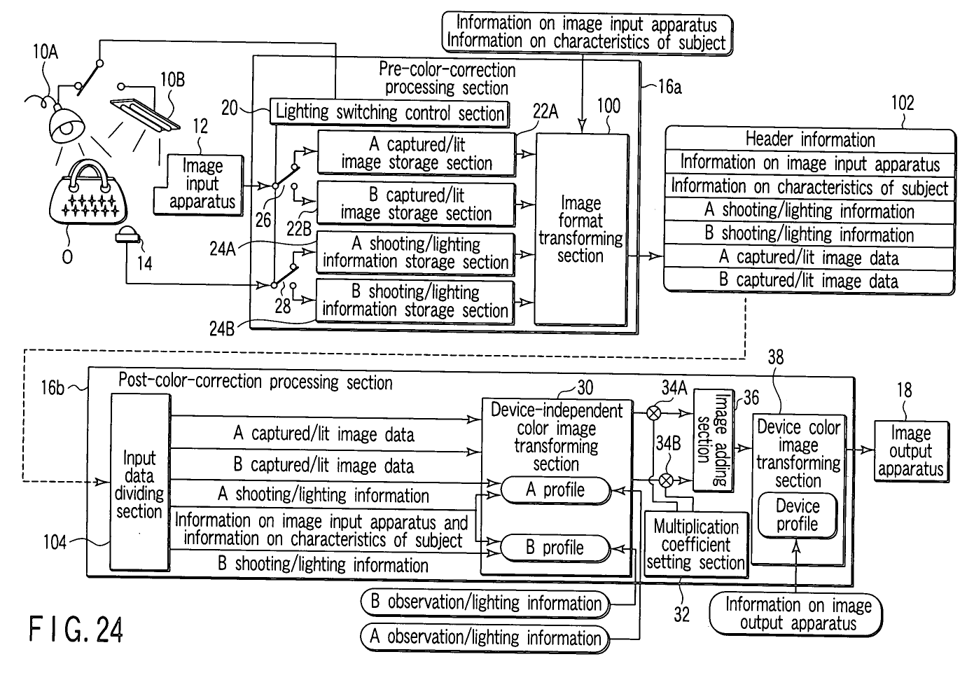

As shown in FIG. 24, the color reproduction system according to a fifth embodiment of the present invention is realized by dividing the color correcting section 16 of the first embodiment into a pre-processing section (pre-color-correction processing section 16a) arranged at the shooting side and a post-processing section (post-color-correction processing section 16b).

The pre-color-correction processing section 16a includes an image format transforming section 100 as well as a lighting switching control section 20, an A captured/lit image storage section 22A, a B captured/lit image storage section 22B, an A shooting/lighting information storage section 24A, a B shooting/lighting information storage section 24B, two switches 26, 28, which are identical with their counterparts of the above-described first embodiment. The image format transforming section 100 receives as input A captured/lit image data, B captured/lit image data, A shooting/lighting information, B shooting/lighting information, information on the image input apparatus and information on the characteristics of the subject, the information on the image input apparatus and the information on the characteristics of the subject being obtained as information on the shooting environment at the image shooting side, and transforms them into image data for isolated lighting 102 having an image format that can be transformed for color changes under the influence of light. Then, the image data for isolated lighting 102 is transmitted to the post-color-correction processing section 16b by way of a network or a storage medium as indicated by a broken line in FIG. 24.

The post-color-correction processing section 16b includes an input data dividing section 104 as well as a device-independent color image transforming section 30, a multiplication coefficient setting section 32, two multipliers 34A, 34B, an image adding section 36 and a device color image transforming section 38, which are identical with their counterparts of the above-described first embodiment. The input data dividing section 104 divides the image data for isolated lighting 102 transmitted and input from the pre-color-correction processing section 16a into the A captured/lit image data, the B captured/lit image data, the A shooting/lighting information, the B shooting/lighting information, the information on the image input apparatus and the information on the characteristics of the subject that are originally input to the image format transforming section 100 and supplies them to the device-independent color image transforming section 30. Thus, it is only necessary to input newly specified A observation/lighting information and B observation/lighting information to the device-independent color image transforming section 30 as external input.

Thus, with the above-described embodiment, it is possible to arbitrarily define light for observation at any remote site to reproduce colors by storing the captured images as image data for isolated lighting 102.

While the present invention is described by way of preferred embodiments, the present invention is by no means limited to the above-described embodiments, which may be modified and applied in various different ways without departing from the spirit and scope of the present invention.

For example, while the subject O is a bag in each of the above-described embodiments, the subject O is by no means limited to a bag and may alternatively be a dress, an accessory, a car, a piece of furniture, an object, a building, a paint, human skin, a tooth or some other thing to achieve similar effects.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

1. A color reproduction system comprising:
an image input apparatus configured to capture an image;
a color correcting section configured to transform the colors of the image captured by the image input apparatus; and
an image output apparatus configured to output by one of displaying and printing the image which is transformed the colors by the color correcting section,
the color correcting section transforming the colors of the input image into those of an output image by using information on the lighting environment at the time of capturing the image, information on the lighting environment at the time of observing the image and information on the image input apparatus, and
the information on the lighting environment at the time of observing the image including information on at least two lighting environments that are different from each other.

2. The system according to claim 1, wherein the color correcting section includes an image adding section configured to add the image with colors transformed by using information on a lighting environment at the time of observing the image and information on another lighting environment at the time of observing the image.

3. The system according to claim 1, wherein the information on the at least two lighting environments at the time of observing the image includes a lighting environment obtained by partly blocking light from a light source and a lighting environment obtained by not blocking light from the light source.

4. The system according to claim 1, wherein the color correcting section is configured to transform colors, using a plurality of images of a same subject captured by the image input apparatus in different lighting environments at the time of capturing.

5. The system according to claim 4, wherein the different lighting environments at the time of capturing differ from each other in terms of at least one of the position, the direction and the profile of light.

6. The system according to claim 4, wherein the different lighting environments at the time of capturing include a state where light is partly blocked and a state where light is not blocked.

7. The system according to claim 4, wherein the different lighting environments at the time of capturing differ from each other in terms of the polarized state of light.

8. The system according to claim 1, wherein the color correcting section is configured to transform the colors by using information on the image output apparatus.

9. The system according to claim 1, wherein the information on light comprises information on the spectrum of light.

10. The system according to claim 1, wherein the color correcting section is configured to transform the colors by additionally using statistic characteristics relating to the spectral reflectivity of the subject.

11. A color reproduction method comprising:
transforming the colors of an image captured by an image input apparatus; and
outputting at an image output apparatus by one of displaying and printing the image which is transformed the colors,
the transforming the colors being transformation of the colors of the input image into those of the output image by using information on the lighting environment at the time of capturing the image, information on the lighting environment at the time of observing the image and information on the image input apparatus, and
the information on the lighting environment at the time of observing the image including information on at least two lighting environments that are different from each other.

12. The method according to claim 11, wherein the transforming the colors includes adding the image with colors transformed by using information on a lighting environment at the time of observing the image and information on another lighting environment at the time of observing the image.

13. A color reproduction system comprising:
image input means for capturing an image;
color correcting means for transforming the colors of the image captured by the image input means; and
image output means for outputting by one of displaying and printing the image which is transformed the colors by the color correcting means,
the color correcting means transforming the colors of the input image into those of an output image by using information on the lighting environment at the time of capturing the image, information on the lighting environment at the time of observing the image and information on the image input means, and
the information on the lighting environment at the time of observing the image including information on at least two lighting environments that are different from each other.
